(19) United States
(12) Patent Application Publication
(10) Pub. No.: US 2023/0394771 A1
(43) Pub. Date: Dec. 7, 2023

(54) Augmented Reality Tracking of Unmanned Systems using Multimodal Input Processing

(71) Applicant: The United States of America as represented by the Secretary of the Navy, San Diego, CA (US)

(72) Inventors: Mark Bilinski, Vista, CA (US); Shibin Parameswaran, San Diego, CA (US); Martin Thomas Jaszewski, San Diego, CA (US); Daniel Sean Jennings, San Diego, CA (US)

(73) Assignee: The United States of America as represented by the Secretary of the Navy, San Diego, CA (US)

(21) Appl. No.: 18/177,970

(22) Filed: Mar. 3, 2023

Related U.S. Application Data
(60) Provisional application No. 63/321,882, filed on Mar. 21, 2022.

(51) Int. Cl. G06T 19/00; G06T 7/70; B64C 39/02

(52) U.S. Cl. CPC G06T 19/006; G06T 7/70; B64C 39/024

(57) ABSTRACT

An apparatus, system, and method for augmented reality tracking of unmanned systems using multimodal input processing, comprising receiving multimodal inputs, calculating unmanned vehicle positions, providing identifiers associated with the unmanned vehicles location, and superimposing the indicators on an augmented reality display. Furthermore, this may include providing an operator/pilot with telemetry information pertaining to unmanned vehicles, task or assignment information, and more.

### CROSS-REFERENCE TO RELATED APPLICATIONS

This application is a non-provisional application claiming priority to U.S. Provisional Patent Application Ser. No. 63/321,882, filed on Mar. 21, 1922, and entitled “Augmented Reality Tracking of Unmanned Systems using Multimodal Input Processing,” the entire content of which is fully incorporated by reference herein.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619)553-5118; email: niwc_patent.fct@us.navy.mil, referencing Navy Case 210,251.

### BACKGROUND

Unmanned systems (“UxVs”) are typically piloted remotely via various displays and controls. On a display, it can be challenging for operators to identify unmanned systems for many reasons including environmental conditions, view obstructions, and their minimal s relative to the distance. Currently, pilots locate UxVs by visually observing a zone of operation or utilize assistants as spotters. In conjunction with visual monitoring unmanned vehicles, pilots often navigate them by referencing telemetry information on a nearby monitor or display. Furthermore, an operator may be tasked with monitoring multiple UxVs, all moving in unique directions and patterns. This complexity substantially increases the mental load on a pilot to maintain situational awareness of all deployed non-adversarial unmanned vehicles. Constantly switching one's attention from visual observation to reviewing telemetry hinders the operator's ability to respond quickly and decisively. Accordingly, there is a need for operators to quickly locate UxVs and become appraised of relevant navigational information despite environmental conditions, distractions, visual obstructions, or task complexity.

### SUMMARY

According to illustrative embodiments, a non-transitory computer-readable storage medium storing instructions that are executable by at least one hardware device processor to provide multi-modal tracking, by receiving motion video of a field of view further comprising a selected field of view; receiving position information for a plurality of unmanned vehicles; initializing a dynamic system model; calculating an initial position for each of the plurality of unmanned vehicles; determining a relative position for each of the plurality of unmanned vehicles; determining whether each of the plurality of unmanned vehicles are within or outside of the field of view; upon determining at least one of the plurality of unmanned vehicles is outside of the field of view, calculating a plurality of suggestive indicators, each associated with each of the plurality of unmanned vehicles outside of the field of view, and updating the dynamic system model with the plurality of suggestive indicators; upon determining at least one of the plurality of unmanned vehicles is within the field of view, calculating a plurality of image positions, each associated with each of the plurality of unmanned vehicles within the field of view, calculating a plurality of final positions, each associated with each of the plurality of unmanned vehicles, by aggregating the relative position and the image position of each unmanned vehicle within the field of view, calculating a plurality of position indicators, each associated with each of the unmanned vehicles within the field of view and selected field of view, calculating the plurality of suggestive indicators, each associated with each of the plurality of unmanned vehicles within the selected field of view and outside the selected field of view, and updating the dynamic system model with the plurality of position indicators and the plurality of suggestive indicators; displaying the selected field of view on an augmented reality display; and superimposing the plurality of suggestive indications and plurality of position indicators over the selected field of view.

Moreover, a computer-implemented method for augmented reality tracking, comprising: receiving motion video of a field of view further comprising a selected field of view; initializing a dynamic system model; determining whether each of a plurality of unmanned vehicles are within the field of view; upon determining whether at least one of the plurality of unmanned vehicles is within the field of view, calculating a plurality of position indicators, each position indicator for each of the plurality of unmanned vehicles, and updating the dynamic system model with the plurality of position indicators; displaying the selected field of view on an augmented reality display; and superimposing the plurality of position indicators over the selected field of view.

Furthermore, a non-adversarial unmanned vehicles tracking system, comprising a plurality of cameras configured to provide a field of view an augmented reality display; a logic device; a storage device comprising instructions executable by the logic device to provide multi-modal tracking.

It is an object to provide a method and system of augmented reality tracking using multimodal input processing that offers numerous benefits, including minimizing acquisition time as the pilot will not have to guess and search for the system. Additionally, the disclosed system and method would make it easier to switch attention between multiple UxVs and, thus, can act as an enabling capability for multi-drone control from a single pilot.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 shows an illustration of current methods of tracking unmanned vehicles.

FIG. 2 shows an illustration of a non-adversarial unmanned vehicles tracking system.

FIG. 3A shows an illustration of an augmented reality display comprising a positional indicator.

FIG. 3B shows an illustration of an augmented reality display comprising a suggestive indicator.

FIG. 3C shows an illustration of an augmented reality display comprising no superimposed indicators.

FIG. 3D shows an illustration of an augmented reality display comprising a positional indicator.

FIG. 4 shows an illustration of an augmented reality display comprising telemetry and supplementary data.

FIG. 5 shows an illustration of an augmented reality display comprising an alert.

FIG. 6A is a block-diagram illustration of steps 601 to 606 for a computer-implemented method for multi-modal tracking.

FIG. 6B is a block-diagram illustration and continuation of FIG. 6A for steps 607 to 617 of a computer-implemented method for multi-modal tracking.

FIG. 7 is a block-diagram illustration of a computer-implemented method for augmented reality tracking.

### DETAILED DESCRIPTION OF EMBODIMENTS

The disclosed system and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other system and methods described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

Additionally, the terms “unmanned vehicles,” “UxVs,” “drones,” or any variation thereof, are intend to cover all unmanned vehicles, vehicle groups, and/or systems. For example, drones may include an array of unmanned aerial vehicles which can be deployed to a zone of operation.

Additionally, the terms “operator,” “pilot,” or any variation thereof, are intend to cover all persons controlling a single unmanned vehicle or a plurality of UxVs.

The instant disclosure comprises system and method to automatically track, identify, and provide information regarding UxVs to operators for various advantages, including reducing acquisition time and reorientation. In one embodiment, the system uses multi-modal inputs from the UxVs to robustly register their geographical location, translate it to the viewing coordinates of an operator's display and provide useful indicators both when an unmanned vehicle is on-screen or off-screen, providing improved situational awareness. Such a system will, for example, assist the UxV operators with gaining a visual of the drone quickly, if they had to avert their attention, control multiple drones and still have awareness of the locations of all of them, receive alerts when they lose control of the UxV(s). Additionally, the system may provide telemetry to the operator that may assist in, for example, the control, direction, or piloting of the UxV.

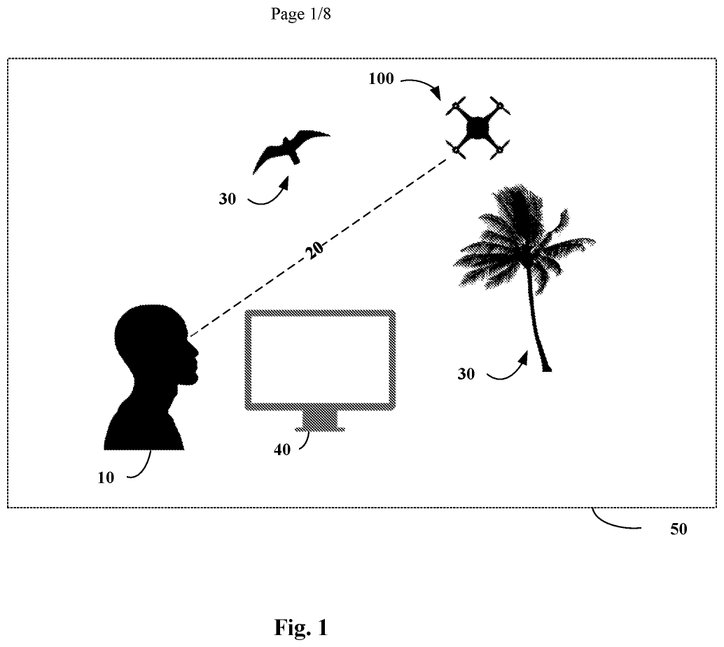

FIG. 1 is an illustration of prior art methods for locating drones comprising an operator 10, line of sight 20, distractions (e.g. bird and tree) 30, controller 40, zone of operation 50 and UxV 100. Commonly, an operator 10 is tasked with both visual tracking of their drone 100, piloting, navigating, and operating any on-board camera or payload. These tasks require the pilot to look down to their controller 40 or display, taking their eyes off of the drone for sometimes extended periods of time. Depending on the size of the drone and its distance from the pilot, as well as background features 30 (i.e. birds, clouds, buildings) it may take the pilot a long time to reacquire visual position of the drone. For example, an operator 10 may look down at his controls and then back up to the UxV 100 to find the drone out-of-sight. As another example, something else in the environment may temporarily catch the pilot's attention such as an obstacle or traffic, or the pilot 10 has multiple drones and must switch their attention from one to another. Consequently, traditional methods require significant time spent on visually reacquiring the UxV 100, which imposes a cognitive drain on the pilot as well as additional potential for things to get missed, resulting in mistakes or accidents.

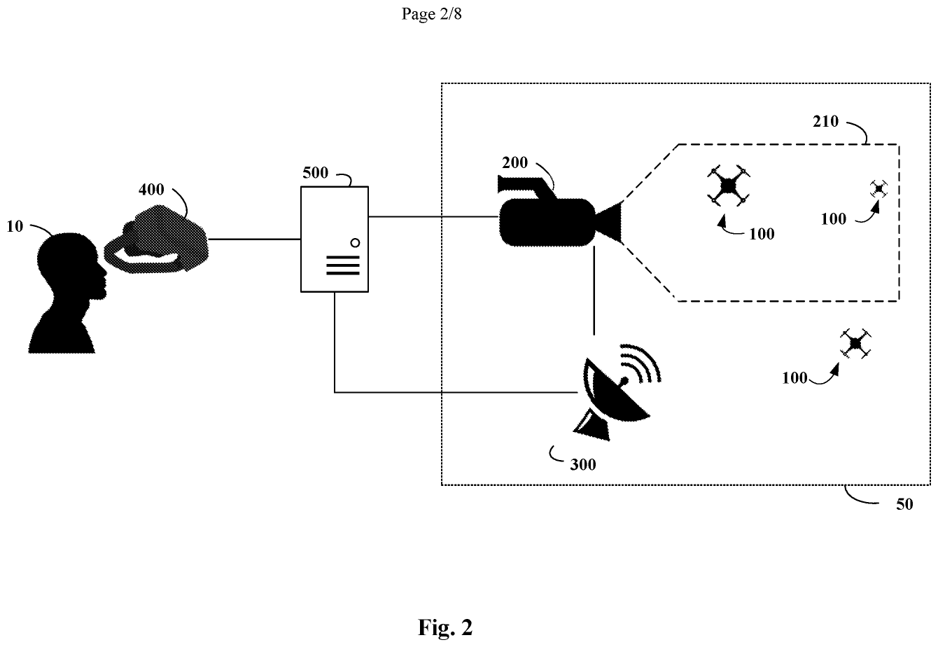

FIG. 2 shows a non-adversarial unmanned vehicle tracking system comprising, consisting of, or consisting essentially of an operator 10, zone of operation 50, plurality of UxVs 100, plurality of cameras 200, field of view 210, tracking equipment 300, an augmented reality display 400, and a logic device 500. The non-adversarial unmanned vehicle tracking system may assist an operator with quickly identifying an UxV and viewing associated information of that UxV that is within the operator's full control. The system may leverage information from many multi-modal inputs to identify, locate, and track UxV including telemetry from each unmanned vehicle, motion video analysis, radar, light detection and ranging, and more. By combining data from multiple inputs, a highly accurate location may be calculated and presented to the pilot in the form of a visual superimposition on an augmented reality display 400. Moreover, this disclosure may be used to identify, track, monitor, and provide telemetry regarding the activities or many UxVs 100 deployed within a zone of operation 50. All of the capabilities discussed herein may apply to the controlling of each of the plurality of UxVs 100. Furthermore, the non-adversarial unmanned vehicle tracking system may receive real-time updates from the multi-modal inputs continuously locate, track, identify, and provide information pertaining to the plurality of UxVs 100.

The plurality of unmanned vehicles 100 are subject to the operation of the pilot (i.e. non-adversarial) and may include air, space, land, or marine vehicles. The UxVs 100 may assist with detection, tracking, and position prediction by incorporating prominent (bright, high contrast, etc.) markings or reflectors, active emission of known signals (radio frequency, infrared light, visible light, ultraviolet light, etc.) or telemetry information of position (i.e. latitude/longitude/altitude) and attitude (i.e. pitch/roll/yaw). Moreover, the unmanned vehicle 100 may further comprise a communication component to transmit data to a logic device 500.

In one embodiment UxVs 100 may also perform autonomous movements or carry out assigned tasks. These tasks may comprise a predicted path in which the unmanned vehicle 100 moves through a pre-determined route. An unmanned vehicles capable of carrying out tasks would allow an operator 10 to assign a task to one drone and avert their attention to assign a task to another one. Information regarding the route, such as a superimposition of the intended path, may be presented to the operator 10 on an AR display 400. Given that paths (e.g. tasks) assigned to the first drone are defined, this system can passively monitor the status by comparing its predicted path and its actual location. If the drone deviates from its predicted path or any technical issues is detected, the system may alert the operator with an indicator (such as red light or a haptic feedback) along with the a direction indicator (with arrows). In this instance, because the UxV 100 is constantly changing position, AR display 400 indicators minimize the reacquisition time for operators 10.

The plurality of cameras 200 may capture motion video of the zone of operation 50 in which the unmanned vehicles are deployed. Motion video of the UxV 100 may be captured, recorded, or collected using any single or combination of fixed cameras, head-mounted cameras, moving cameras, etc. Examples of “cameras” may include, but are not limited to: conventional color video camera, infrared camera (active or passive), neuromorphic/event camera, LIDAR, sonar, synthetic aperture radar, etc. Additionally, the plurality of cameras 200 may, in some embodiments, be head mounted and/or controllable by the operator. For example, the operator may be able to swivel their head and cause a shift in the camera angle. As another example, the operator could use controls to pan left/right, up/down, or in/out. In one embodiment, the plurality of cameras 200 employ multiple cameras to hand off an UxV's 100 position from camera to camera as the camera fields of view overlap with the UxV's 100 known or predicted position.

The zone of operations 50 is the area in which the UxV 100 are deployed and operated. While traditional methods of tracking require the operator 10 to be within or adjacent to the zone of operation 50, the system and method described herein allows the operator to be within, adjacent to, or remote from the zone of operation 50.

Tracking equipment 300 may be used to determine position information for unmanned vehicles 100 and provide that information to the augmented reality display 400. For example, the tracking equipment 300 may utilize ground controller's telemetry information, which may include any information that the ground controller presents to the pilot. As another example, the tracking technology may comprise Wi-Fi or radiofrequency triangulation, passive computer vision, point-to-point laser tracking, or even the drone reporting its own telemetry via a communications link. Telemetry may also include: heading, velocity, altitude, payload, and data stream.

In some embodiments, UxVs have on-board cameras that may provide motion video from the drone's 100 point of view. This motion video may be presented within the augmented reality display 400, providing the pilot 10 a quick way to check the drone's point-of-view without having to look down to the controller. Moreover, some modalities (video and telemetry) of the system may work together in a complementary fashion, and may also be used separately. The coupled and independent operational capability will allow the system or the pilot to decide when to use both modalities and/or drop a modality if in a given setting it is error-prone (e.g. computer vision in rain or with a lot of distractors such as birds).

The augmented reality display 400 comprises a selected field of view 410 and may present position indicators 420, suggestive indicators 430, telemetry 311, and supplementary data 312. The selected field of view 410 is a portion of the field of view 210 collected by the plurality of cameras 200 that is viewable by the operator 10. While the total field of view 210 that may be available to an operator 10, it is common to focus on a portion of that field of view. The selected field of view 410 may be either selected or moved by the operator within the total field of view 210. Additionally, a position indicator 420 or suggestive indicator 430 may optionally be not present to an operator 10 depending on use conditions. For example, an indicator could be selectively shown for a single UxV 100 while the indicators associated with other UxVs are transparent or hidden.

Furthermore, position indicators 420, suggestive indicators 430, telemetry 311, and supplementary data 312 may be superimposed over the selected field of view 410 to assist the pilot 10 with locating and monitoring the UxVs 100. This may include, in lieu of the telemetry and information previously discussed, weather information or wider situational awareness aid (i.e. a map or information about other units/forces in the area). Additionally, this might include clocks, timers, mission progress instruments, and more. In one embodiment, the AR display 400 is a wearable headset. In another embodiment, the AR display 400 is a handheld display. Additionally, the AR displays 400 may also have embedded cameras or sensors to dynamically detect the display's orientation. To illustrate, an AR headset display may have an embedded sensor that may be used to detect where the operator 10 is looking and alter the selected field of view 410 according to the operator 10 orientation.

The logic device 500 is a generic computing device capable of receiving motion video from the plurality of cameras 200, receiving telemetry 311 from the telemetry equipment 300, receiving telemetry 311 or supplemental data 312 the unmanned vehicles 100 within a zone of operation 50, aggregating multi-modal position information, and calculating position indicators 420 or suggestion indicators 430 for an augmented reality display 400 overlay. Furthermore, the logic device 500 is electrically connected or wirelessly connected to the AR display 400.

To aggregate multi-modal position information and calculator indicators, the logic device 500 may initialize a dynamic system model. The dynamic system model is a computer simulation of the zone of operation and may be represented in two-dimensional (2D) and/or three-dimensional (3D) form factors. For example, in an air environment the dynamic system model may represent the airspace as, for example, a semi-sphere. The dynamic system model may incorporate multiples modes of input to calculate relative positions of UxV positions that allow an operator to locate UxVs 100 from the perspective of the cameras.

Furthermore, the logic device may calculate an initial position, relative position, and/or final position of a plurality of UxVs 100. An initial position is a geographical position based on position information which may include, for example, geographic coordinates. Relative positions are calculated based on the location of the cameras 200, the camera's orientation, and the geographical position of the UxVs. More specifically, multi-modal analysis utilizes data from the available sources to calculate a position relative to the operator's view and position. The final position may be calculated with an aggregation of computer vision analysis of an image position and the relative position. The final position may also take into consideration possible error in the data sources to refine accuracy. Moreover, these position calculation may enable the dynamic system model to render a 3D frustum of unmanned vehicle 100 positions.

After determining a relative position for each of the plurality of unmanned vehicles, the logic device 500 may determine if each unmanned vehicle is within the selected field of view 410. UxVs within the selected field of view may be highlighted with an on-screen position indicator 420. This indicator is calculated based on the available multi-modal inputs, which may include motion video and telemetry. The position indicator 420 highlights the UxV's 100 on-screen position for the operator 10 and, in one embodiment, may be a circle. Once the position of the indicator is calculated, the dynamic system model is updated and prepared for display. If an UxV 100 is outside of the selected field of view 410, a suggestive indicator may be calculated based on available multi-modal data. In one case, motion video analysis may not be available for an UxV 100 not within the field of view, but telemetry may be available. Accordingly, an on-screen indicator of an off-screen position (suggestive indicator) 430 may then be generated with the telemetry input. In another case, the UxV 100 may be within the field of view, and therefore have motion video capable of analysis, but not within the operator 10 selected field of view. Therefore, both motion video analysis and telemetry could be used to generate a suggestive indication. The suggestive indicator 430, in one embodiment, may present a graphical representation of an UxV and an arrow pointing outward from the edge of the augmented reality display 400 in the direction that the operation 10 would need to look to find the UxV 100. A multimodal information processing approach enhances a robust detection and tracking system that may correct for any errors in the individual domains (e.g. error in the telemetry-based registration or computer vision errors due to false positives or missed detects) and improve accuracy.

One source may be motion video analysis. Computer vision technology may analyze the motion video to locate a plurality of unmanned vehicles and monitor their position within the field of view 210. As the image of an UxV is tracked, the logic device 500 calculates an UxV position and updates the dynamic system model with an indicator associated with each UxV's 100 position. The relative position for any UxV corresponds to the field of view 210 captured by the plurality of camera's 200.

Another multi-modal source may be received telemetry 311. Telemetry 311 may be provided by an unmanned vehicle or from tracking equipment 312 (e.g. ground control data). This position may be used independent of motion video analysis, or used in conjunction with computer vision to calculate a position for the UxV. Telemetry 311 may include depth information from, for example, light detecting and ranging implements. Depth information allows the dynamic system model to render a 3D frustum of unmanned vehicle 100 positions. Accordingly, indicators are then situated in three-dimensional space from the perspective of an operator 10. This allows the operator to zoom in or out of the field of view 210 to better see identify the unmanned vehicles 100.

In one embodiment, the system and method disclosed consists of multiple tracking source that work together to best refine the UxVs 100 position relative to the pilot. For example, the UxV 100 could be sending back telemetry data 311 and the Augmented Reality headset's own position tracking then is able to provide a rough estimate for the drone's 100 position in the context of the operator's 10 line of sight. Then computer vision processes imagery from cameras 200 on the headset to further refine the position. Errors in tracking the Augmented Reality headset's 400 exact position and orientation may result in the initial rough estimate of the drone's position to be visually off (a few degrees can result in a few cm's of visual error). However, that initial estimate makes the computer vision task of spotting the drone easier and faster and then the computer vision detection will refine the drone's position and make for a better visual estimate for the pilot. Either tracking technology provides identifying information to the operator, but use together may enhance accuracy and ease of use.

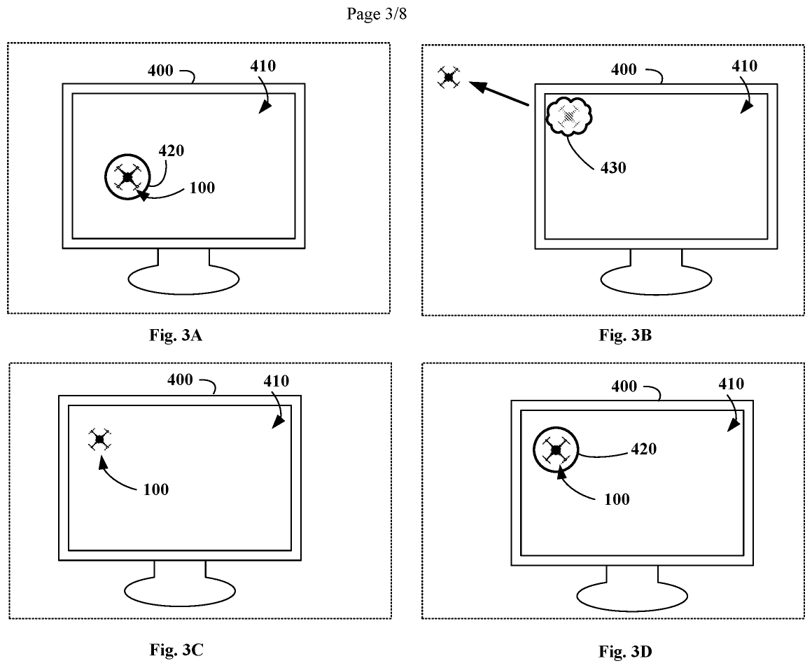

FIGS. 3(a), 3(b), 3(c), and 3(d) show four illustrations of an AR display 400 with examples of UxV 100 locations and superimposed graphics. The AR display 400 may assist an operator 10 with finding an unmanned vehicle's 100 location with a position indicator 420 or with an on-screen indication of off-screen position (“suggestive indicator”) 430. A positional indicator 420 is a graphical superimposition over the selected field of view 410 that highlights an unmanned vehicles 100 on-screen position. As an example, FIG. 3(a) shows a position indicator 420 as a circle. On the other hand, a suggestive indicator 430 directs the operator 10 to the location of an UxV outside of the selective field of view 410, as illustrated in FIG. 3(b). The indicators are easily viewable by the operator and may highlight a particular UxV or multiple UxVs. Notably, the dotted lines in FIGS. 3(a), 3(b), 3(c), and 3(d) merely separate the figures and are not components of the disclosure herein.

FIG. 3(a) shows an UxV 100 highlighted by a position indicator 420 within the selected field of view 410 and presented on an augmented reality display 400.

FIG. 3(b) shows an UxV 101 outside of the selected field of view 410 and a suggestive indicator 420 of an UxVs off-screen position. The unmanned vehicle 100 is not within the selected field of view, but may or may not be within the total field of view captured by the plurality of cameras 200. If the UxV 100 is within the field of view, motion video analysis may be a mode of input to determine the position of the UxV 100. If the UxV is outside of the field of view, the system or method discussed herein will utilize position information directly from the UxV 100 or other telemetry sources 300. In either case, at least one mode of input is sufficient to determine an UxV's 100 location and further information may further fine-tune the position calculation.

FIG. 3(c) shows an UxV 100 recaptured by the selected field of view 410, but not yet highlighted by a position indicator 420. There may be a delay between the moment an unmanned vehicle appears on the AR display 400 and when a position indicator 420 is rendered. FIG. 3(c) may be understood is immediately preceding the illustration shown in FIG. 3(d).

FIG. 3(d) shows an UxV 101 recaptured by the field of view and identified with predictive position based on telemetry information and video analysis.

In one embodiment, the positional indicator 410 is supplemented with a target highlight. If an operator, for example, wants to focus on a particular unmanned vehicle, their focus may be aided by this additional target highlighting. This may take the form of a different color position indicator, or supplementary graphics text, for some examples.

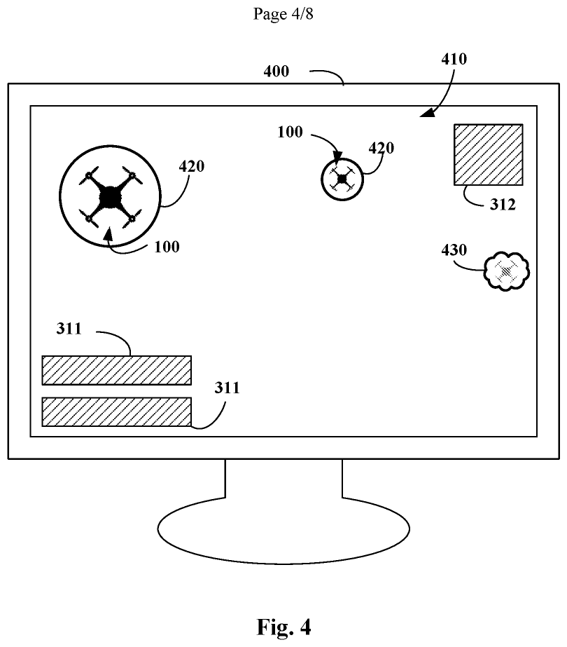

FIG. 4 shows an example augmented reality display 400 comprising selected field of view 410, a plurality of unmanned vehicles 100, position indicators 420, a suggestive indicator 430, telemetry 311, and supplemental data 312. This illustration of one embodiment that may help an operator 10 visually acquire and control an UxV. As discussed previously, telemetry 311 may include heading, velocity, and direction for a selected/target UxV. Additionally, the supplementary data 312 may include a motion video feed communicated from the UxV or a miniaturized map of the zone of operation 50. Such indicators and auxiliary information greatly reduce acquisition time for pilots, allowing them to respond quickly to the needs of one or many deployed UxVs.

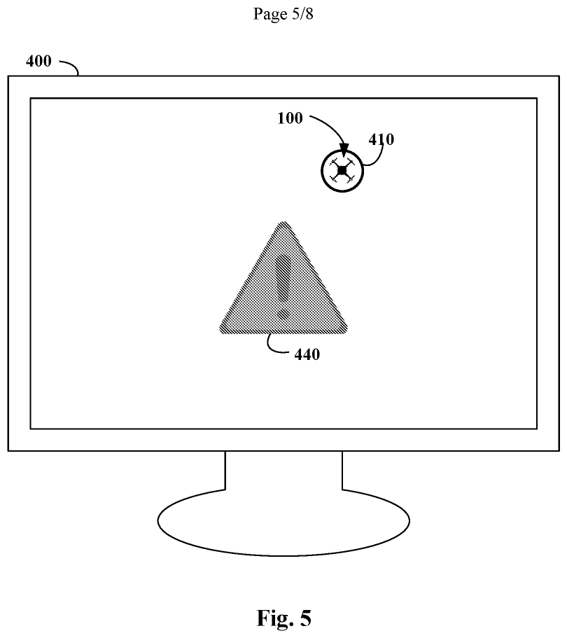

FIG. 5 shows an example augmented reality display 400 comprising a selected field of view 410, plurality of unmanned vehicles 100, a position indicator 420, and an alert 440. An alert 440 is presented to the operator 10 when a noteworthy event occurs that required his or her attention. For example, an alert 440 may be presented when an unmanned vehicle strays from their predicted or assigned path. As discussed previously, drones 100 may be tasked to autonomously carry out tasks or move in a particular pattern. Outside factors include system errors, obstacles, or environmental conditions may cause the unmanned vehicle to stray from the path. An alert 440 is activated based on an unexpected position and enables a pilot 10 to reorient their attention.

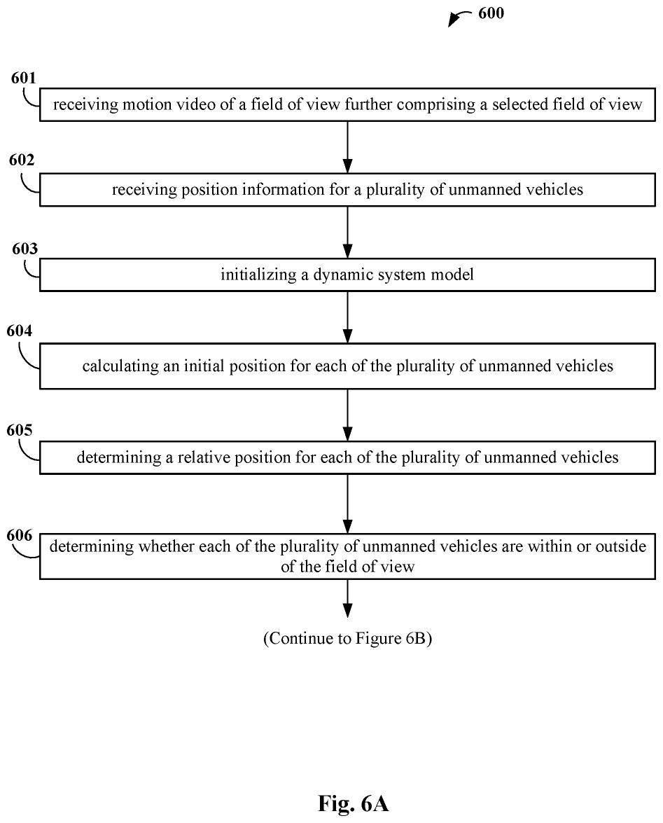

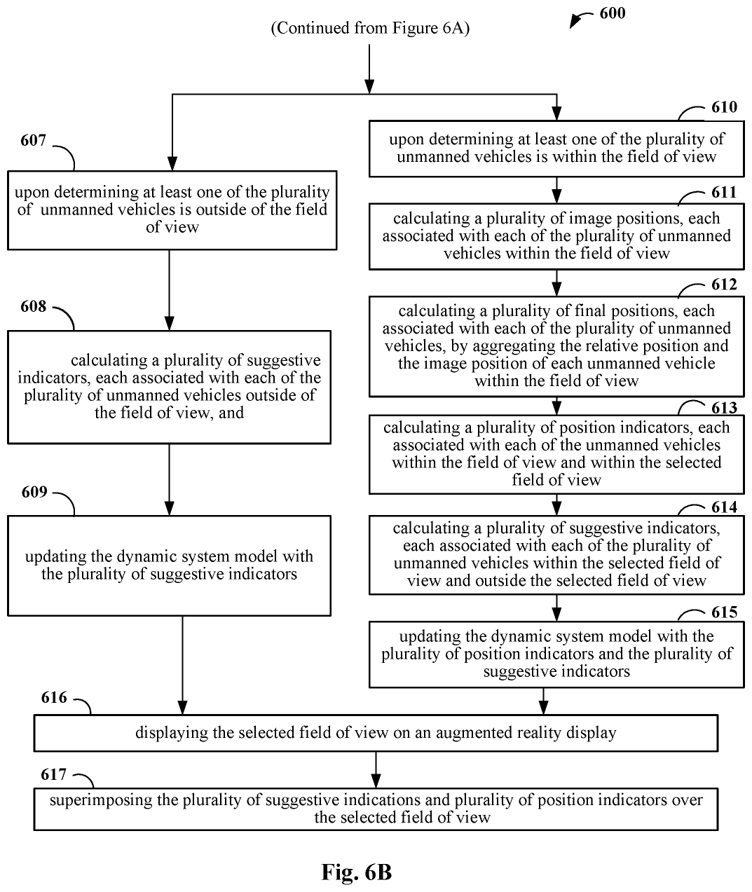

FIG. 6A shows a block-diagram illustration of non-transitory computer-readable storage medium storing instructions that are executable by at least one hardware device processor to provide multi-modal tracking by receiving motion video of a field of view further comprising a selected field of view 601; receiving position information for a plurality of unmanned vehicles 602; initializing a dynamic system model 603; calculating an initial position for each of the plurality of unmanned vehicles 604; determining a relative position for each of the plurality of unmanned vehicles 605; determining whether each of the plurality of unmanned vehicles are within or outside of the field of view 606.

FIG. 6B shows a continuation of FIG. 6A, which further comprises: upon determining at least one of the plurality of unmanned vehicles is outside of the field of view 607; calculating a plurality of suggestive indicators, each associated with each of the plurality of unmanned vehicles outside of the field of view, and 608 updating the dynamic system model with the plurality of suggestive indicators 609, upon determining at least one of the plurality of unmanned vehicles is within the field of view 610, calculating a plurality of image positions, each associated with each of the plurality of unmanned vehicles within the field of view 611, calculating a plurality of final positions, each associated with each of the plurality of unmanned vehicles, by aggregating the relative position and the image position of each unmanned vehicle within the field of view 612, calculating a plurality of position indicators, each associated with each of the unmanned vehicles within the field of view and selected field of view 613; calculating the plurality of suggestive indicators, each associated with each of the plurality of unmanned vehicles within the selected field of view and outside the selected field of view, and 614; updating the dynamic system model with the plurality of position indicators and the plurality of suggestive indicators 615; displaying the selected field of view on an augmented reality display; and 616 superimposing the plurality of suggestive indications and plurality of position indicators over the selected field of view 617.

The computer-implemented method for multi-modal tracking may further comprise the steps of: selecting a target unmanned vehicle having an indicator, wherein the indicator is the position indicator or the suggestive indicator; superimposing a target highlight over the indicator; superimposing telemetry over the selected field of view, wherein the telemetry is associated with the position of the target unmanned vehicle.

The computer-implemented method for multi-modal tracking may further comprise the step of: receiving supplementary motion video from one of the plurality of unmanned vehicles; superimposing the selected field of view with the supplementary motion video.

The computer-implemented method for multi-modal tracking may further comprise the step of: receiving task information comprising a predicted path for at least one unmanned vehicles; calculating an augmented reality visualization of the predicted path; superimposing the augmented reality visualization the selected field of view. A computer-implemented method for multi-modal tracking of claim 1, further comprising the step of: receiving a status update from the plurality of unmanned vehicles; superimposing a status notification over the selected field of view.

The computer-implemented method for multi-modal tracking may further comprise the step of continuously receiving a video stream and updated position information for each of the plurality of unmanned vehicles; and updating the plurality of position indicators and plurality of suggestive indicators utilizing the video stream and the updated position information.

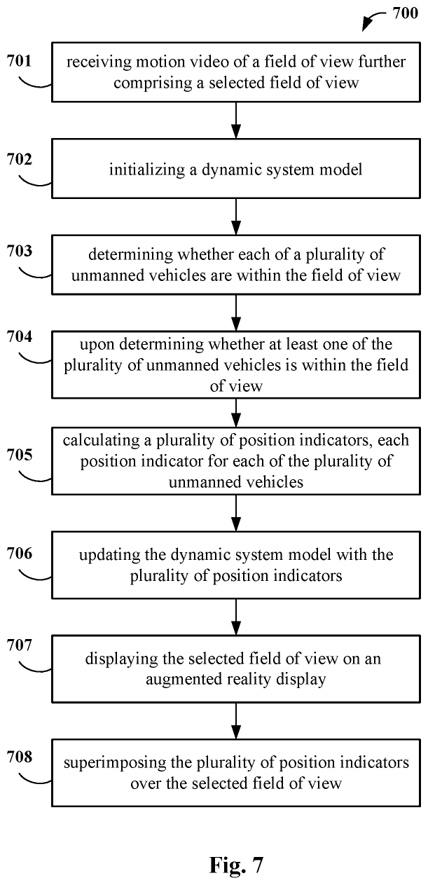

FIG. 7 shows a block-diagram illustration of a computer-implemented method for augmented reality tracking, comprising receiving motion video of a field of view further comprising a selected field of view 701; initializing a dynamic system model 702; determining whether each of a plurality of unmanned vehicles are within the field of view 703; upon determining whether at least one of the plurality of unmanned vehicles is within the field of view 704, calculating a plurality of position indicators, each position indicator for each of the plurality of unmanned vehicles 705, updating the dynamic system model with the plurality of position indicators 706; displaying the selected field of view on an augmented reality display 707; and superimposing the plurality of position indicators over the selected field of view 708.

The computer-implemented method for augmented reality tracking of claim 6 may further comprise continuously receiving a video stream of the field of view; and updating the plurality of position indicators for each of the plurality of unmanned vehicles based on the video stream.

The computer-implemented method for augmented reality tracking of claim 6 may further comprise the steps of: selecting a target unmanned vehicle, wherein the target unmanned vehicle is associated with one of the plurality of unmanned vehicles having one of the plurality of position indicators; and superimposing a target highlight over the position indicator.

The computer-implemented method for augmented reality tracking may further comprise the step of: receiving supplementary motion video from one of the plurality of unmanned vehicles; superimposing the selected field of view with the supplementary motion video.

The computer-implemented method for augmented reality tracking may further comprise the step of: receiving task information comprising a predicted path for at least one unmanned vehicle; calculating an augmented reality visualization of the predicted path; superimposing the augmented reality visualization the selected field of view.

The computer-implemented method for augmented reality tracking may further comprise the step of: receiving a status update from the plurality of unmanned vehicles; superimposing a status notification over the selected field of view.

From the above description of augmented reality tracking of unmanned systems using multi-modal input processing, it is manifest that various techniques may be used for implementing the concepts of a computer-implemented method for multi-modal tracking, a computer-implemented method for augmented reality tracking, and a non-adversarial unmanned vehicles tracking system without departing from the scope of the claims. The described embodiments are to be considered in all respects as illustrative and not restrictive. The method/system disclosed herein may be practiced in the absence of any element that is not specifically claimed and/or disclosed herein. It should also be understood that a computer-implemented method for multi-modal tracking, a computer-implemented method for augmented reality tracking, and a non-adversarial unmanned vehicles tracking system are not limited to the particular embodiments described herein, but is capable of many embodiments without departing from the scope of the claims.

What is claimed:

1. A non-transitory computer-readable storage medium storing instructions that are executable by at least one hardware device processor to provide multi-modal tracking, by:
receiving motion video of a field of view further comprising a selected field of view;
receiving position information for a plurality of unmanned vehicles;
initializing a dynamic system model;
calculating an initial position for each of the plurality of unmanned vehicles;
determining a relative position for each of the plurality of unmanned vehicles;
determining whether each of the plurality of unmanned vehicles are within or outside of the field of view;
upon determining at least one of the plurality of unmanned vehicles is outside of the field of view,
calculating a plurality of suggestive indicators, each associated with each of the plurality of unmanned vehicles outside of the field of view, and
updating the dynamic system model with the plurality of suggestive indicators;
upon determining at least one of the plurality of unmanned vehicles is within the field of view,
calculating a plurality of image positions, each associated with each of the plurality of unmanned vehicles within the field of view,
calculating a plurality of final positions, each associated with each of the plurality of unmanned vehicles, by aggregating the relative position and the image position of each unmanned vehicle within the field of view,
calculating a plurality of position indicators, each associated with each of the unmanned vehicles within the field of view and selected field of view,
calculating the plurality of suggestive indicators, each associated with each of the plurality of unmanned vehicles within the selected field of view and outside the selected field of view, and
updating the dynamic system model with the plurality of position indicators and the plurality of suggestive indicators;
displaying the selected field of view on an augmented reality display; and
superimposing the plurality of suggestive indications and plurality of position indicators over the selected field of view.

2. The non-transitory computer-readable storage medium of claim 1, further comprising the steps of:
selecting a target unmanned vehicle having an indicator, wherein the indicator is the position indicator or the suggestive indicator;
superimposing a target highlight over the indicator;
superimposing telemetry over the selected field of view, wherein the telemetry is associated with the position of the target unmanned vehicle.

3. The non-transitory computer-readable storage medium of claim 1, further comprising the step of:
receiving supplementary motion video from one of the plurality of unmanned vehicles;
superimposing the selected field of view with the supplementary motion video.

4. The non-transitory computer-readable storage medium of claim 1, further comprising the step of:
receiving task information comprising a predicted path for at least one unmanned vehicle;
calculating an augmented reality visualization of the predicted path;
superimposing the augmented reality visualization within the selected field of view.

5. The non-transitory computer-readable storage medium of claim 1, further comprising the step of:
receiving a status update from the plurality of unmanned vehicles;
superimposing a status notification over the selected field of view.

6. The non-transitory computer-readable storage medium of claim 1, further comprising the step of:
continuously receiving a video stream and updated position information for each of the plurality of unmanned vehicles; and
updating the plurality of position indicators and plurality of suggestive indicators utilizing the video stream and the updated position information.

7. A computer-implemented method for augmented reality tracking, comprising:
receiving motion video of a field of view further comprising a selected field of view;
initializing a dynamic system model;
determining whether each of a plurality of unmanned vehicles are within the field of view;
upon determining whether at least one of the plurality of unmanned vehicles is within the field of view,
calculating a plurality of position indicators, each position indicator for each of the plurality of unmanned vehicles, and
updating the dynamic system model with the plurality of position indicators;
displaying the selected field of view on an augmented reality display; and
superimposing the plurality of position indicators over the selected field of view.

8. The non-transitory computer-readable storage medium of claim 7, further comprising the steps of:
continuously receiving a video stream of the field of view; and
updating the plurality of position indicators for each of the plurality of unmanned vehicles based on the video stream.

9. The computer-implemented method for augmented reality tracking of claim 7, further comprising the steps of:
selecting a target unmanned vehicle, wherein the target unmanned vehicle is associated with one of the plurality of unmanned vehicles having one of the plurality of position indicators; and
superimposing a target highlight over the position indicator.

10. The computer-implemented method for augmented reality tracking of claim 7, further comprising the steps of:
receiving supplementary motion video from one of the plurality of unmanned vehicles; and
superimposing the selected field of view with the supplementary motion video.

11. The computer-implemented method for augmented reality tracking of claim 7, further comprising the steps of:
receiving task information comprising a predicted path for at least one unmanned vehicle; and
calculating an augmented reality visualization of the predicted path;
superimposing the augmented reality visualization within the selected field of view.

12. The computer-implemented method for augmented reality tracking of claim 7, further comprising the steps of:
receiving a status update from the plurality of unmanned vehicles; and
superimposing a status notification over the selected field of view.

13. A non-adversarial unmanned vehicles tracking system, comprising:
a plurality of cameras configured to provide a field of view;
an augmented reality display;
a logic device;
a storage device comprising instructions executable by the logic device to provide multi-modal tracking, by:
receiving the field of view further comprising a selected field of view;
receiving position information for a plurality of unmanned vehicles;
initializing a dynamic system model;
calculating an initial position for each of the plurality of unmanned vehicles;
determining a relative position for each of the plurality of unmanned vehicles;
determining whether each of the plurality of unmanned vehicles are within or outside of the field of view;
upon determining at least one of the plurality of unmanned vehicles is outside of the field of view,
calculating a plurality of suggestive indicators, each associated with each of the plurality of unmanned vehicles outside of the field of view, and
updating the dynamic system model with the plurality of suggestive indicators;
upon determining at least one of the plurality of unmanned vehicles is within the field of view,
calculating a plurality of image positions, each associated with each of the plurality of unmanned vehicles within the field of view,
calculating a plurality of final positions, each associated with each of the plurality of unmanned vehicles, by aggregating the relative position and the image position of each unmanned vehicle within the field of view,
calculating a plurality of position indicators, each associated with each of the unmanned vehicles within the field of view and selected field of view,
calculating the plurality of suggestive indicators, each associated with each of the plurality of unmanned vehicles within the selected field of view and outside the selected field of view, and
updating the dynamic system model with the plurality of position indicators and the plurality of suggestive indicators;
displaying the selected field of view on the augmented reality display; and
superimposing the plurality of suggestive indications and plurality of position indicators over the selected field of view.

14. The non-adversarial UxV tracking system of claim 13, further comprising:
tracking equipment configured to provide the position information.

15. The non-adversarial UxV tracking system of claim 13, wherein at least one of the plurality of unmanned vehicles is associated with a task having a predicted path.

16. The non-adversarial UxV tracking system of claim 15, wherein the augmented reality display presents an alert that the at least one unmanned vehicle associated with a task has deviated from the predicted path.

17. The non-adversarial UxV tracking system of claim 13, wherein at least one position identifier advises that an UxV is outside of the field of view and provides a suggestive indicator.

18. The non-adversarial UxV tracking system of claim 13, wherein the augmented reality display is a heads-up-display.

19. The non-adversarial UxV tracking system of claim 13, wherein the selected field of view is controllable by an operator.

20. The non-adversarial UxV tracking system of claim 13, wherein at least one of the plurality of cameras is a head-mounted camera unit.
